(19) United States
(12) Patent Application Publication
(10) Pub. No.: US 2006/0232817 A1
(43) Pub. Date: Oct. 19, 2006

(54) Internet data transmitting system which improves a communication area stage technology field

(76) Inventors: Hajime Mouri, Hajima-City (JP); Yasuo Nakaya, Matsumoto-City (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/403,350

(22) Filed: Apr. 13, 2006

(30) Foreign Application Priority Data
Apr. 13, 2005 (JP) 2005-116053

(51) Int. Cl. G06F 3/12

(52) U.S. Cl. 358/1.15

(57) ABSTRACT

An data transmission system for transmitting data from a homepage server to a user on an area network is provided. The data transmission system includes a homepage server and an area network. The area network comprises a base station, a subhomepage server, and at least one area network member. The subhomepage server stores data from the homepage server when data is transmitted to a network member. When a network member makes a data request to the homepage server, the subhomepage server determines if the data requested is stored on the subhome page server. If the requested data is stored on the subhomepage server then the subhomepage server transmits the data to the network member. If the requested data is not stored on the subhomepage server then the data request is sent to the homepage server which then transmits the requested data to the subhomepage server which in turn transmits the data to the network member.

### BACKGROUND

In the course of internet data transmission, an FTP server will communicate with a second server to request information. The second server is often the only source of the requested information. The FTP server may communicates with the second server via a special communication line. When multiple data transmissions occur simultneously, the special communication line becomes congested and communication speed can be decreased. This present application discloses a data buffer function in the relay system.

Where a pyramid is shaped and stratified, and how to set up the relay station that aimed at lightening the burden on the FTP server side as is. However, the data and the contents of the buffer are the latest. Due to the confirmation of the data in the FTP server being acquired, the data can be renewed. In addition; when there is a data requirement from the terminal, you must do the data transmission every time if they are in the data, which are not in the data buffer. When a data requirement was concentrated on the FTP server, it is restricted by the communication of the special line, and the communication speed decreases, a load was concentrated on the FTP server and an answer speed sometimes decreased.

So far, the FTP server transmitting from that is installed in one place. There was a problem which the special line equipment to maintain a communication speed. Also, a high speed FTP server should be necessary. When this invention transmits homepage information, the aim at making a big capacity communication possible with making a taste of the communication to a minimum. This method, which is easy to introduce, can be provided with low cost.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present invention, in the data transmission of the internet, arrange a main homepage server in the provider. Also, arrange a main homepage server in the relay station where it is installed. It is installed by the connection part of the communication circuit from the area base office and the member base circuit. This is tied with,the main homepage server which has a function that the renewal notice and data transmission are done in the main homepage server at the control signal from the data kept when the function which keeps the data that the data was received by the control signal from the homepage server. Also the member saves the data requirement so that the data transmission uses the sub-homepage server and has a function to do the Internet data transmission system, which improves data transmission in the Internet by doing data transmission from the sub-homepage server when a member does a data requirement.

In accordance with another embodiment of the present invention, when a member does a data requirement, as for the sub homepage server installed in the relay station, the control signal that the one toward the member is transmitted is transmitted in main homepage server. A transmitting main homepage server transmits a control signal based on the renewal information and renewal data in the sub-homepage server the Internet data transmitting system that transmits a message to the member from the sub-homepage server.

In accordance with yet another embodiment of the present invention, even if communication data from the main homepage server are of high digital compression communication in the member terminal this receives information in the first and second embodiments. Making it possible that it doesn't to do that and it is received. The Internet transmitting system transmits the data to a sub-homepage server does high digital compression and not to a member.

In the previously described embodiments, the relay station has a sub-homepage server. In accordance with still another embodiment of the present invention, by arranging it in the constant interval and when a communication speed decreases by the distance, the member circuit can imagine it, and the communication speed of the sub-homepage server can have the required high-speed requirement data relay station and the sub-homepage server method.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a diagram for a relay station connection formed in accordance with one embodiment of the present invention.

FIG. 2 illustrates a diagram for an area network connection formed in accordance with one embodiment of the present invention.

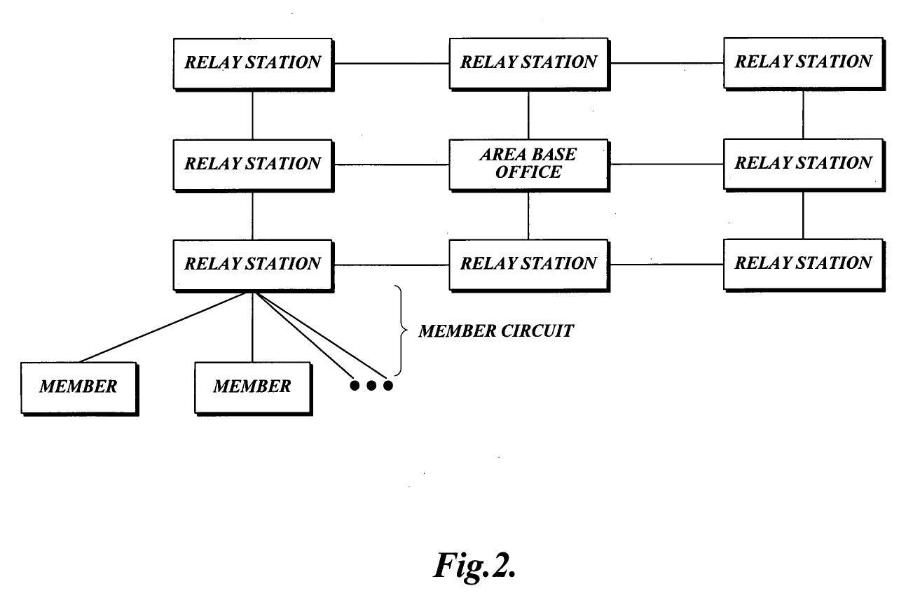

### DETAILED DESCRIPTION

While illustrative embodiments have been illustrated and described, it will be appreciated that various changes can be made therein without departing from the spirit and scope of the invention.

Store data in the main homepage server of this invention and then more than one sub-homepage server can attain the above purpose. A main homepage server transmits information from the sub homepage put on the relay place by the control signal from the member, it is the way of connecting in which it is aimed at solving the above subject.

So far, as it is possible, it is the way of connecting to try to reduce it in the control signal to 5.3 bytes in the transmission, which can result in communication loss. Then, when access was concentrated so far in low speed the capacity of the communication circuit of the server, though it became the condition that it couldn't be connected, where it can communicate at high speed can be secured. The information stored in the FTP server by connecting a reproduction server with the member circuit directly. The transmission of not taking an influence by increasing the hard disks of the server in the performance of he special line, which became stable, was made possible. This is technology. And as for the special line, the home page information, it is the method, which improves communication efficiency in the special line drastically to use it only for a control signal to take out, and power transmission, reception of the renewal information. The effect of the invention

It seems that it was shown in the above, and storing the data, which are the same as the main homepage, server in the sub homepage server installed in more than one relay station in the relay station. By making communication in the Internet with only control signal and renewal information, a minimum can have communication loss. Even if a special line in a wide area isn't used make the data transmission, which became stable with high speed possible. This is the best way to improve communication efficiency in special line drastically.

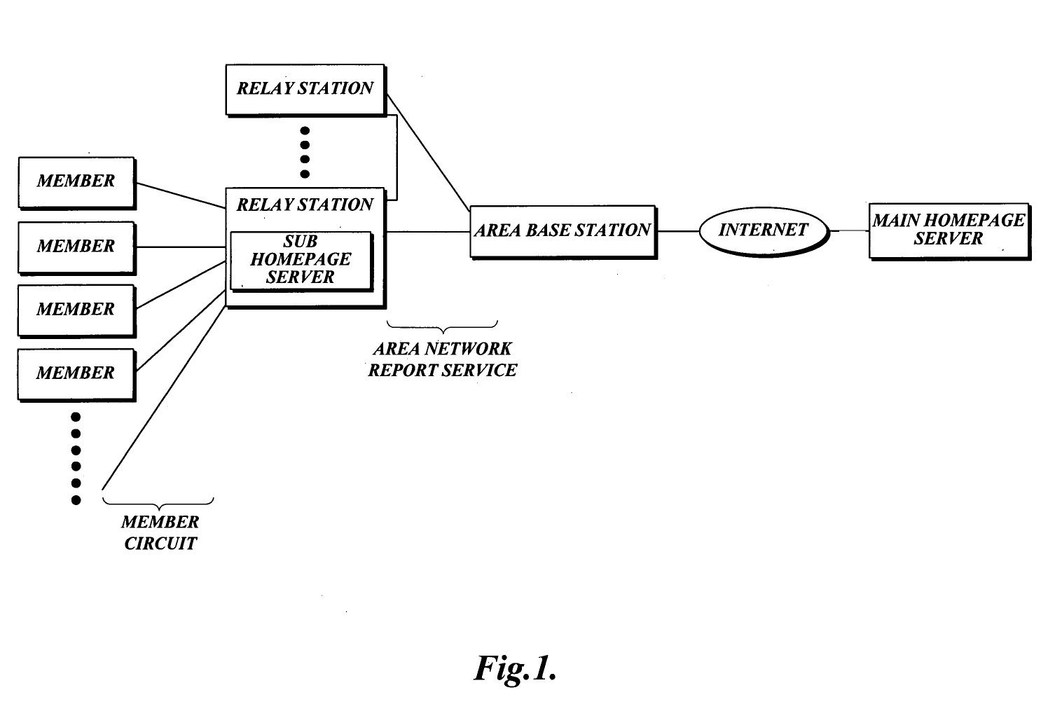

In one embodiment of the present invention, a sub-homepage server is installed in the relay station where it is installed while generally a member circuit and an area base office (are connected with NTT base office) as shown in the FIG. 1.0 In the sub homepage server, general OS (in such cases as Windows and Unix us) have carried a computer and it is here. Use the connection of the communication circuit and the sub homepage through the switch. Install a main homepage server in the provider. When data on the main homepage server are usually renewed, renewal data is transmitted in all the base offices. By doing the data renewal of the sub-homepage serve inside the relay station where t is arranged by less than an area base office. Try in the hard disk of the sub-homepage server by this work so that the data, which are the same as the data on the main homepage servers, are always kept. However, a control signal toward the data requirement is transmitted from the member when information such as a homepage is required from the member to make it cope with data to renew in real time and which are indicated too. Check it with the data based on the control signal from the member in the sub-homepage server, and make the list of the data list and the time stamp. And a message is transmitted in the main homepage server. After the main homepage server confirms the list data, a main homepage server transmits a collation result and change in the sub-homepage server. At this time, a main homepage server takes a transmitting record, and it is removed from the data renewal of the next sub-homepage server. The amount of data transmission inside the special line can be kept to a minimum because the communication of the main homepage server is done with the data transmission that a high digital style is compressed.

A function corresponding to the high digital compression shouldn't be necessary for a sub homepage server in the terminal on the member side because data transmission is done without preparing all the data and doing digital compression to the member.

It can communicate at high speed with the sub-homepage server and a member imagines communication by installing it several hundred times in the interval the relay station, the communication of the main homepage server, even if it goes, a member can get the advantage that it can communicate in super-high speed fully.

A minimum can do a communication speed decline for the member even if a communication circuit between the relay station and the area base office uses the way of communicating that the optical fiber cable and the radio communication vary.

The embodiments of the invention in which an exclusive property or privilege is claimed are defined as follows:

1. A data transmitting system comprising:
a) a main homepage server;
b) an area network comprising an area base station, a subhomepage server, and at one area network member;
wherein the subhomepage server receives information from the main homepage server and stores the information to transmit to a member when the member makes a data request to the homepage server.
